(19) United States
(12) Patent Application Publication
(10) Pub. No.: US 2014/0097996 A1
(43) Pub. Date: Apr. 10, 2014

(54) TUNABLE ELECTROMAGNETIC DEVICE WITH MULTIPLE METAMATERIAL LAYERS, AND METHOD

(71) Applicant: RAYTHEON COMPANY, Waltham, MA (US)

(72) Inventors: Jacquelyn A. Vitaz, Medford, MA (US); Christopher P. Mccarroll, Andover, MA (US); Mary K. Herndon, Littleton, MA (US)

(73) Assignee: Raytheon Company, Waltham, MA (US)

(21) Appl. No.: 13/648,464

(22) Filed: Oct. 10, 2012

(51) Int. Cl. H01Q 15/00; H01Q 1/52; H01Q 1/42

(52) U.S. Cl. 343/841; 343/872; 343/909

(57) ABSTRACT

A tunable electromagnetic device includes at least two overlapping metamaterial layers, wherein the metamaterial layers are selectively tunable by patterned conductive structures that are parts of the metamaterial layers. By selectively altering the properties of the metamaterial layers with the patterned conductive structures, the frequency response of the electromagnetic device can be controlled, to selectively let electromagnetic energy of certain frequencies pass through, or alternatively to prevent pass-through of substantially all frequencies of electromagnetic energy. In addition the frequencies for which electromagnetic energy passes through may be altered by controlling one or more of the tunable metamaterial layers. The tunable electromagnetic device may be used to selectively shield radar or other types of sensors, for example being used as all or part of the skin of a vehicle or other object.

### BACKGROUND OF THE INVENTION

1. Field of the Invention

The invention is in the field of tunable electromagnetic devices, such as frequency selective surfaces.

2. Description of the Related Art

Antennas are often placed behind radomes. Radomes are structures which protect the antenna, and which allow electromagnetic energy to pass through in both directions. Often the radome is made so that it transmits electromagnetic energy in a narrow band centered around the operating frequency of the antenna. Frequency selective surfaces, with a grid or lattice of metal patterns or holes in a metal sheet, may be used for this purpose and additionally to deflect or reflect jamming signals at other frequencies. However, such frequency selective surfaces may have the disadvantage of being very selective as to the range of frequencies that they will allow to pass through. Also, such surfaces may have the disadvantage of not being able fully to block incoming electromagnetic energy at all frequencies of interest. Such full blocking would be useful when the antenna is not operating, as the antenna may be made in such a case to appear similar to the surrounding environment or objects, for example appearing to radar as a sheet of metal. This may help in hiding the radar from detection by enemy radar or other sensors.

### SUMMARY OF THE INVENTION

According to an aspect of the invention, a tunable electromagnetic device includes: a first tunable metamaterial layer; and a second tunable metamaterial layer. The metamaterial layers at least partially physically overlap. Additional tunable metamaterial layers may also be included in the stack.

According to another aspect of the invention, a method of shielding a device that receives and/or sends electromagnetic energy, the method including: selectively altering transmission properties of a tunable electromagnetic device that at least partially covers the device that receives and/or sends electromagnetic energy. The tunable electromagnetic device includes: a first tunable metamaterial layer; and a second tunable metamaterial layer. The metamaterial layers at least partially physically overlap. Altering transmission properties includes selectively altering transmission properties of at least one of the metamaterial layers.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 shows an oblique view of an object that is partially covered by a tunable electromagnetic device in accordance with an embodiment of the present invention.

FIG. 2 is an exploded view of the tunable electromagnetic device of FIG. 1.

FIG. 3 is a first graph schematically illustrating operation of the tunable electromagnetic device of FIG. 1.

FIG. 4 is a second graph schematically illustrating operation of the tunable electromagnetic device of FIG. 1.

FIG. 5 is a third graph schematically illustrating operation of the tunable electromagnetic device of FIG. 1.

FIG. 6 is an exploded view of a tunable electromagnetic device in accordance with an alternate embodiment the invention.

FIG. 7 is an oblique view showing further details of a metamaterial layer of the tunable electromagnetic device of FIG. 6.

### DETAILED DESCRIPTION

A tunable electromagnetic device includes at least two overlapping metamaterial layers, wherein the metamaterial layers are selectively tunable by an externally applied means. By selectively altering the properties of the metamaterial layers the frequency response of the electromagnetic device can be controlled, to selectively allow electromagnetic energy of certain frequencies pass through, or alternatively to prevent pass-through of substantially all frequencies of electromagnetic energy. In addition the frequencies for which electromagnetic energy passes through may be altered by controlling one or more of the tunable metamaterial layers. The tunable electromagnetic device may be used to selectively shield radar or other types of sensors, for example being used as all or part of the skin of a vehicle or other object.

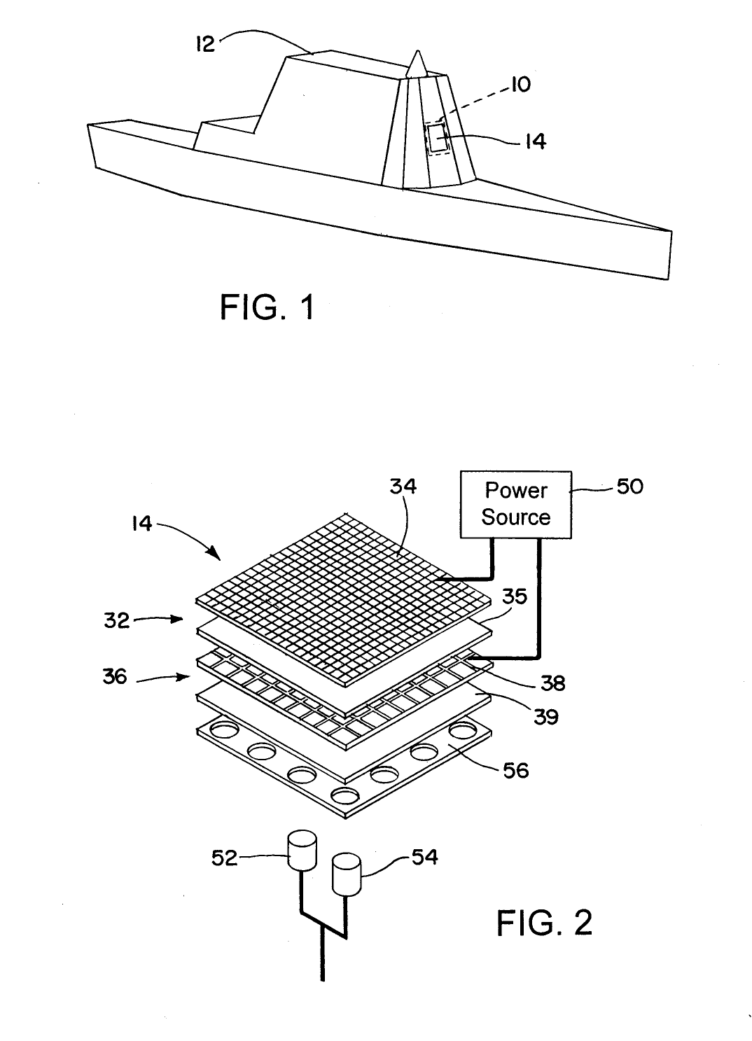

FIG. 1 shows an antenna or other device that receives and/or sends electromagnetic energy 10 on an object 12 (a ship in the illustrated embodiment), covered by a radome or skin 14. The object 12 may be any of a variety of objects, for example being any of a variety of vehicles, such as ground, sea, or air vehicles, such as ships, missiles, airplanes, unmanned aerial vehicles, or submarines, to give a few possibilities. The radome or skin 14 may form part of the outer skin of the object 12. The radome or skin 14 may be a tunable electromagnetic device, with characteristics that may be controlled by a user, for example to change the electromagnetic frequency response of the radome or skin 14.

FIG. 2 shows further details of the tunable electromagnetic device 14. The tunable electromagnetic device 14 includes a first metamaterial 32, having a first patterned conductive structure 34 on a first substrate material layer 35, and a second metamaterial 36, having a second patterned conductive structure 38 on a second substrate material layer 39. The metamaterial layers 32 and 36 at least partially physically overlap, and one of the metamaterial layers may substantially fully physically overlap the other metamaterial layer. The patterned conductive structures 34 and 38 are operatively coupled to the respective substrate material layers 35 and 39, to allow selectively alternation of the properties of the metamaterial layers 32 and 36. The transmission properties of the tunable metamaterial layers 32 and 36, the frequency range of electromagnetic energy that passes through them, is alterable by selectively activating circuitry in the patterned conductive structures 34 and 38. The conductive structures 34 and 38 may be on one or both major surfaces of the substrate material layers 35 and 39.

The metamaterial layers 32 and 36 may include any of a variety of tunable metamaterials. Metamaterials are materials or combinations of materials that have been engineered to have properties that may not be found in nature. One type of metamaterials is tunable metamaterials, a term that is used herein to refer to a metamaterial with a variable response to an incident electromagnetic wave.

The substrate material layers 35 and 39 may include any of a variety of suitable materials. Examples of suitable materials include ferroelectric materials, for example barium titanates (such as barium strontium titanate), lead titanates, lanthanum titanates, lead arsenate, or ferroelectric polyvinylidene fluoride (PVDF) polymer. The substrate material layers 35 and 39 may have a thickness of from 50 to 500 nm, or more narrowly about 200 nm (although other thicknesses are possible).

The patterned conductive structures 34 and 38 are periodic arrays of metallic (or other electrically conductive) elements with specific geometric shapes, or periodic apertures in a metal (or other electrically conductive material) screen. These periodic arrays may be considered arrays of circuit elements, and form subharmonic structures. The transmission and reflection coefficients for the arrays are dependent on the characteristics of operation, such as the frequency and/or of voltages applied to the patterned conductive structures 34 and 38. The patterned conductive structures 34 and 38 may use any of a variety of suitably-shaped repeating elements or apertures, including squares, circles, and crosses of various configurations (such as Jerusalem crosses). The patterned conductive structures 34 and 38 may have a pair of sets of parallel conductive lines, with the conductive lines in one set being perpendicular to the other set of conductive lines, for example. Elements, such as capacitive elements, diodes, varactor diodes, or other circuit elements, may be placed at various locations between adjacent of the conductive lines. Applying controlled voltages from one or more power sources 50 to the conductive lines, varies the characteristics of the metamaterial layers 32 and 36 in terms of what frequencies of electromagnetic energy will pass through the metamaterial layers 32 and 36. Further details regarding the general arrangement of metamaterial layers and associated conductive structures for controlling frequency response, reference may be had to U.S. Pat. No. 7,612,718, the description and figures of which are incorporated herein by reference.

U.S. Pat. No. 7,612,718 describes an apparatus and methods for operating a frequency selective surface. Lines of conductors are placed on one or both major surfaces of a metamaterial layer. Circuit elements, such as varactor diodes, are placed between the lines of conductive material. Providing voltage differences across adjacent of the conductor lines, at a given frequency, will alter the inherent capacitance of the system, thereby changing the frequency response of the material.

In the lattice described in U.S. Pat. No. 7,612,718 the distance between adjacent conductor lines may be from 1/15 of the wavelength to ½ of the wavelength. The conductive structures 34 and 38 may have distances between conductor lines that are an order of magnitude less. This results in conductive structures 34 and 38 that have greater concentration, allowing greater control of the properties of the metamaterial layers 32 and 36.

The electromagnetic device 14 may cover a sensor/antenna, such as radiofrequency (RF) feeds 52 and 54. The RF feeds 52 and 54 may be parts of an antenna for use in sending and receiving signals, as part of a radar system. The feeds 52 and 54 may feed through holes in a metal sheet 56. Other sorts of devices that send and/or receive electromagnetic energy may be covered at least in part by the electromagnetic device 14.

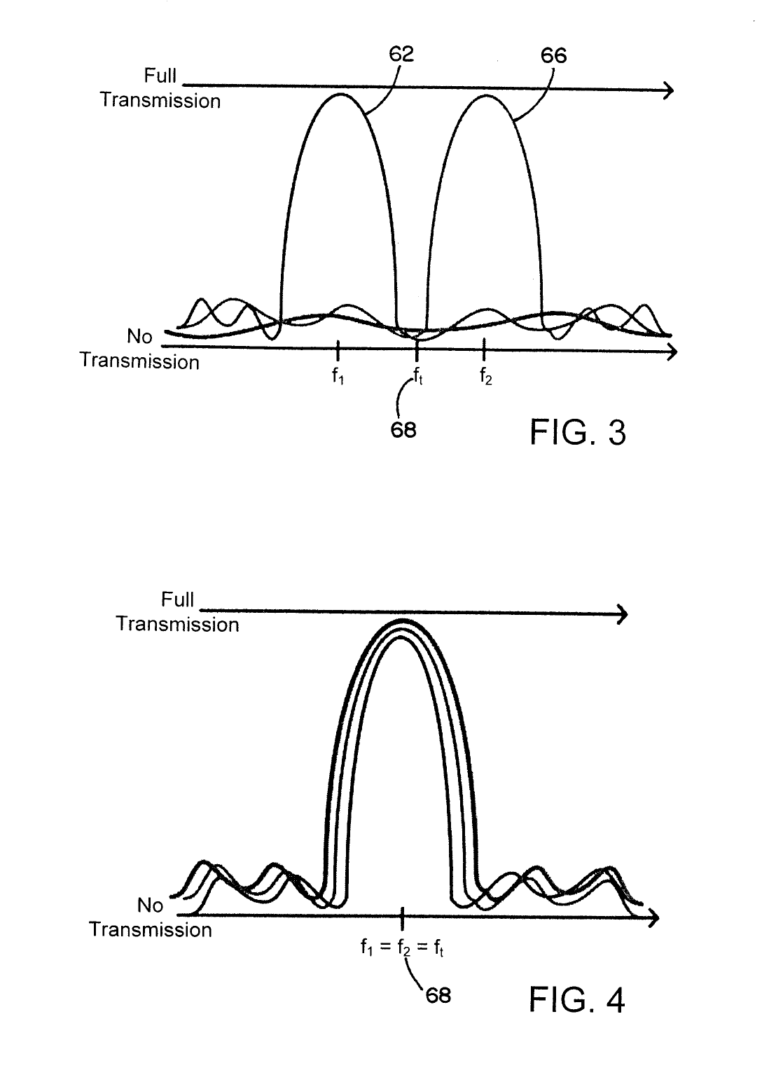

The two metamaterial layers 32 and 36 may be independently controlled to achieve any of a variety of effects. The tunable electromagnetic device 14 may be tuned to provide a high degree of isolation (preventing ingress and egress of electromagnetic radiation) by tuning the metamaterial layers 32 and 36 so that their transmissive parts of the frequency spectrum have substantially no frequency overlap. This is illustrated in FIG. 3, which shows the frequencies 62 and 66 offset from a natural (unadjusted) frequency 68 of the metamaterial layers 32 and 36 (FIG. 2). Without tuning, the electromagnetic device 14 may have aligned frequency response, as shown in FIG. 4, with the response of both of the metamaterial layers 32 and 36 (FIG. 2) centered on the natural frequency 68 (or some other similar frequency). With the transmissive windows of the metamaterial layers 32 and 36 (FIG. 2) aligned, electromagnetic radiation can be passed through the electromagnetic device over a full range of wavelengths that the untuned metamaterial layers 32 and 36 are transmissive for.

The electromagnetic device 14 may be used to selectively allow transmission of electromagnetic energy therethrough at some times, while blocking substantially all transmission at other times. For example, the electromagnetic device 14 may be configured (such as by being selectively tuned) to allowed electromagnetic energy through for operation of a radar system, when the radar system is sending and receiving signals, and to reflect electromagnetic energy when the radar system is not operating. This makes the radar system less visible to enemy radar, since the electromagnetic device 14 appears similar to surrounding electromagnetically-reflecting surfaces, such as the metal skin of an aircraft, other vehicle, or other object.

The tunable electromagnetic device 14 may be used for any of a variety of purposes. Besides shielding radar systems, it may be used for shielding any of a variety of other sensors and devices, such as communications devices, electronic warfare devices for transmitting and/or receiving signals, and radiofrequency (RF) sensors. In addition, the tuning of the metamaterial layers 32 and 36 may be modulated to control the bandwidth of the open frequency range of electromagnetic radiation that passes through the electromagnetic device 14. By partially separating the frequency responses of the metamaterial layers 32 and 36 (by selective tuning of the metamaterial layers 32 and 36), the frequency range of the opening can be tailored to be similar to that of the radar system or other device that sends and/or receives electromagnetic energy passing through the electromagnetic device 14. For example, the frequency range may be set 1-2% wider than the bandwidth of a radar system antenna (or other antenna, sensor, or device).

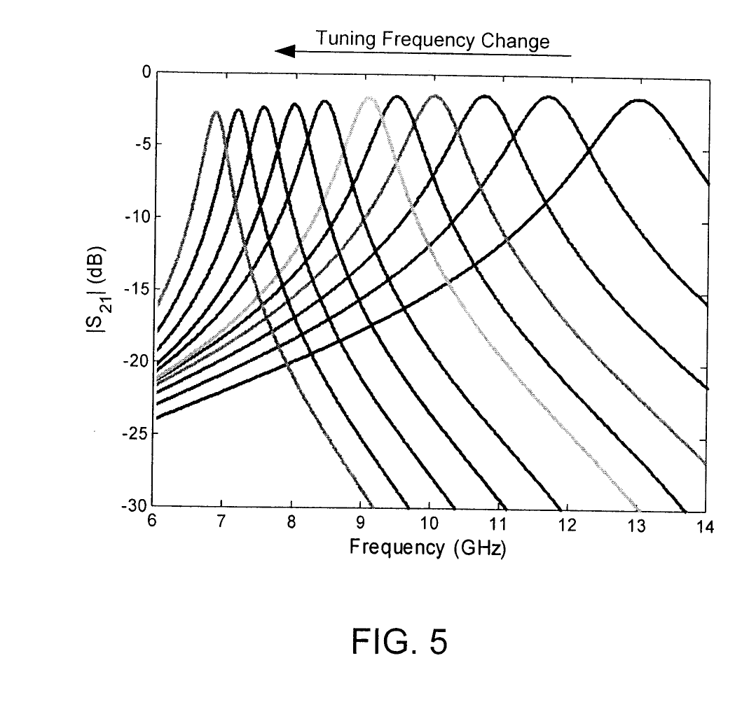

Alternatively or in addition, the bandwidth of a frequency window may be a function of frequency. As illustrated in FIG. 5, the bandwidth of the transmission window may decrease as the metamaterial layers 32 and 36 are tuned to reduce the frequency of the maximum transmission.

The metamaterial layers 32 and 36 may be made of the same materials, with or without having the same tunability properties, or may be made of different materials, having different properties. To give one example of the size of the electromagnetic device 14, the device 14 may be on the order of 1 lambda (where lambda corresponds to the wavelength of the target operating frequency) in each of the lateral directions, with each of the substrate metamaterial layers 35 and 39 having a thickness of 10 mils, and each of the conductive structures 34 and 38 having 400 circuit elements. However, the electromagnetic device 14 may have a wide variety of other sizes, for example being large enough to cover a surface of a large vehicle, such as a ship.

The tunable electromagnetic device 14 may provide various advantages in use. It reduces or otherwise alters the radar signature of a sensor system, such as a radar antenna. The signature can be reduced by closing the transmission window when the radar or other sensor is not in use, as well as by shaping the transmission window (its bandwidth and peak frequency) by controlling the transmission properties of the metamaterial layers 32 and 36. The tunable electromagnetic device 14 may be used to change the radar signature in other ways, by altering the transmission properties to achieve other effects.

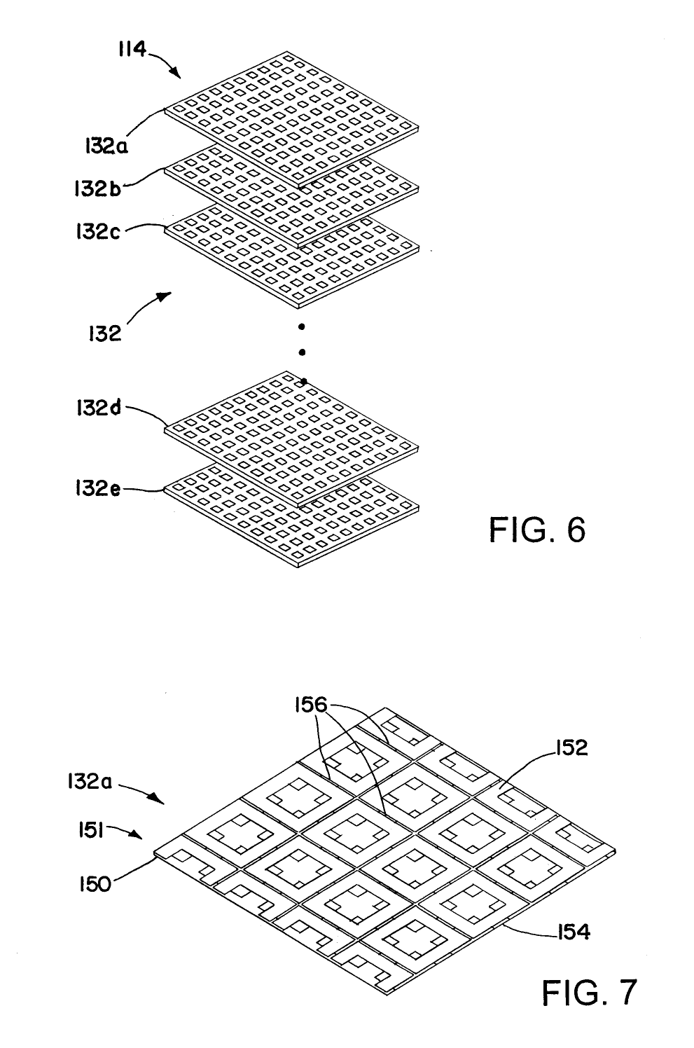

FIG. 6 shows an alternative configuration, a tunable electromagnetic device 114 that has multiple metamaterial layers 132. Five of the metamaterial layers 132 (metamaterial layers 132a, 132b, 132c, 132d, and 132e) are shown in the illustrated device 114, but it will be appreciated that the device 114 may have any number of multiple metamaterial layers 132 that at least partially physically overlap. FIG. 7 shows one possible configuration for one of the metamaterial layers 132a, with a central material layer (substrate) 150 having a conductive structure 151 on it, for controlling transmission properties of the metamaterial layer 132a. The conductive structure 151 includes a first patterned conductive structure portion 152 on a front face or major surface, and a second patterned conductive structure portion 154 on a rear face or major surface. The conductive structures 152 and 154 may constitute grids, such as metal grids, that interact to allow tuning of the frequency response of the metamaterial layer 132a. Capacitive elements 156 may link parts of the first conductive structure 152. The capacitive elements 156 may provide, in conjunction with inductive elements, for different effects in controlling the transmission properties of the metamaterial layer 132a. More broadly, the capacitive and inductive elements may change the transmission properties of the metamaterial layer 132a. Various filtering effects may be obtained, for example providing the effect of a high pass filter (only allowing frequencies above a given cutoff frequency through), a low pass filter (only allowing frequencies below a given cutoff frequency through), or a bandpass filter (only allowing frequencies within a certain frequency window through). The metamaterial layers 132 may all be the same in terms of materials and configuration, or some may be different from others. The additional metamaterial layers 132 may be used to achieve a variety of transmission effects. Alternatively or in addition, one or more of the metamaterial layers may operate as an antenna, a sensor, and/or another device for sending and/or receiving electromagnetic energy.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A tunable electromagnetic device comprising:
a first tunable metamaterial layer; and
a second tunable metamaterial layer;
wherein the metamaterial layers at least partially physically overlap.

2. The device of claim 1,
wherein the tunable metamaterial layers each include:
a substrate material layer; and
an electrically-conductive structure on at least one surface of the substrate material layer; and
wherein for each of the metamaterial layers the electrically-conductive structure is operatively coupled to the substrate material layer, to tune transmission properties of the metamaterial layers.

3. The device of claim 2, wherein for each of the metamaterial layers the electrically-conductive structure is on opposed major surfaces of the substrate material layer.

4. The device of claim 2, wherein the electrically-conductive structures are subharmonic periodic arrays.

5. The device of claim 2, wherein the electrically-conductive structures include capacitive elements.

6. The device of claim 2, wherein the electrically-conductive structures are operatively coupled to one or more power sources.

7. The device of claim 2, wherein the substrate material layers are the same material.

8. The device of claim 2, wherein the substrate material layers are different materials.

9. The device of claim 1, wherein the tunable metamaterial layers are substantially identical in function.

10. The device of claim 1, in combination with a device that receives and/or sends electromagnetic energy through the tunable electromagnetic device.

11. The combination of claim 10, wherein the device that receives and/or sends electromagnetic energy is part of a radar system, and wherein the tunable electromagnetic device functions as a radome.

12. The combination of claim 11, wherein the device that receives and/or sends electromagnetic energy is an antenna of the radar system.

13. The combination of claim 10 wherein the device that receives and/or sends electromagnetic energy is a sensor.

14. The device of claim 1, in combination with an object;
wherein the electromagnetic layers include a skin covering part of an object.

15. The combination of claim 14, wherein the object is a vehicle.

16. The combination of claim 15, wherein the vehicle is a water vehicle.

17. A method of shielding a device that receives and/or sends electromagnetic energy, the method comprising:
selectively altering transmission properties of a tunable electromagnetic device that at least partially covers the device that receives and/or sends electromagnetic energy;
wherein the tunable electromagnetic device includes:
a first tunable metamaterial layer; and
a second tunable metamaterial layer;
wherein the metamaterial layers at least partially physically overlap; and
wherein the altering transmission properties including selectively altering transmission properties of at least one of the metamaterial layers.

18. The method of claim 17,
wherein the device that receives and/or sends electromagnetic energy is an antenna that is part of a radar system; and
wherein the selectively altering transmission properties includes blocking incoming and outgoing electromagnetic energy from passing through the tunable electromagnetic device when the radar system is not operating.

19. The method of claim 17
wherein the tunable metamaterial layers each include:
a substrate material layer; and
an electrically-conductive structure on at least one surface of the substrate material layer;
wherein for each of the metamaterial layers the electrically-conductive structure is operatively coupled to the substrate material layer, to tune transmission properties of the metamaterial layers; and
wherein the selectively altering transmission properties includes providing voltages to at least one of the electrically-conductive structures.

20. The method of claim 17, wherein the selectively altering transmission properties includes selectively altering transmission properties of both of the tunable metamaterial layers in opposite directions, so that tunable electromagnetic device allows substantially no electromagnetic energy to pass therethrough.
